(19) United States
(12) Patent Application Publication
(10) Pub. No.: US 2024/0056832 A1
(43) Pub. Date: Feb. 15, 2024

(54) UNIFIED TRANSMISSION CONFIGURATION INDICATOR FRAMEWORK FOR SINGLE FREQUENCY NETWORK OPERATIONS

(71) Applicant: QUALCOMM Incorporated, San Diego, CA (US)

(72) Inventors: Kiran VENUGOPAL, Green Brook, NJ (US); Wooseok NAM, San Diego, CA (US); Tao LUO, San Diego, CA (US); Junyi LI, Fairless Hills, PA (US)

(21) Appl. No.: 17/819,143

(22) Filed: Aug. 11, 2022

(51) Int. Cl. H04W 16/28; H04B 7/01

(52) U.S. Cl. CPC H04W 16/28; H04B 7/01

(57) ABSTRACT

Various aspects of the present disclosure generally relate to wireless communication. In some aspects, a user equipment (UE) may receive, from a network node, configuration information indicating a single frequency network (SFN) scheme to be applied by the UE. The UE may receive, from the network node, a transmission configuration indicator (TCI) codepoint indicating two or more TCI states associated with the SFN scheme. The UE may receive, from the network node, a beam indication that is associated with a unified TCI state indication, wherein the beam indication indicates at least one of: updated information for a TCI state, from the two or more TCI states, or that the two or more TCI states are associated with multiple downlink channels. Numerous other aspects are described.

### FIELD OF THE DISCLOSURE

Aspects of the present disclosure generally relate to wireless communication and to techniques and apparatuses for a unified transmission configuration indicator (TCI) framework for single frequency network (SFN) operations.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive, from a network node, configuration information indicating a single frequency network (SFN) scheme to be applied by the UE. The one or more processors may be configured to receive, from the network node, a transmission configuration indicator (TCI) codepoint indicating two or more TCI states associated with the SFN scheme. The one or more processors may be configured to receive, from the network node, a beam indication that is associated with a unified TCI state indication, wherein the beam indication indicates at least one of: updated information for a TCI state, from the two or more TCI states, or that the two or more TCI states are associated with multiple downlink channels.

Some aspects described herein relate to a network node for wireless communication. The network node may include a memory and one or more processors coupled to the memory. The one or more processors may be configured to transmit configuration information, associated with a UE, indicating an SFN scheme to be applied by the UE. The one or more processors may be configured to transmit a TCI codepoint, associated with the UE, indicating two or more TCI states associated with the SFN scheme. The one or more processors may be configured to transmit a beam indication, associated with the UE, that is associated with a unified TCI state indication, wherein the beam indication indicates at least one of: updated information for a TCI state, from the two or more TCI states, or that the two or more TCI states are associated with multiple downlink channels.

Some aspects described herein relate to a method of wireless communication performed by a UE. The method may include receiving, from a network node, configuration information indicating an SFN scheme to be applied by the UE. The method may include receiving, from the network node, a TCI codepoint indicating two or more TCI states associated with the SFN scheme. The method may include receiving, from the network node, a beam indication that is associated with a unified TCI state indication, wherein the beam indication indicates at least one of, updated information for a TCI state, from the two or more TCI states, or that the two or more TCI states are associated with multiple downlink channels.

Some aspects described herein relate to a method of wireless communication performed by a network node. The method may include transmitting configuration information, associated with a UE, indicating an SFN scheme to be applied by the UE. The method may include transmitting a TCI codepoint, associated with the UE, indicating two or more TCI states associated with the SFN scheme. The method may include transmitting a beam indication, associated with the UE, that is associated with a unified TCI state indication, wherein the beam indication indicates at least one of, updated information for a TCI state, from the two or more TCI states, or that the two or more TCI states are associated with multiple downlink channels.

Some aspects described herein relate to a non-transitory computer-readable medium that stores a set of instructions for wireless communication by an UE. The set of instructions, when executed by one or more processors of the UE, may cause the UE to receive, from a network node, configuration information indicating an SFN scheme to be applied by the UE. The set of instructions, when executed by one or more processors of the UE, may cause the UE to receive, from the network node, a TCI codepoint indicating two or more TCI states associated with the SFN scheme. The set of instructions, when executed by one or more processors of the UE, may cause the UE to receive, from the network node, a beam indication that is associated with a unified TCI state indication, wherein the beam indication indicates at least one of: updated information for a TCI state, from the two or more TCI states, or that the two or more TCI states are associated with multiple downlink channels.

Some aspects described herein relate to a non-transitory computer-readable medium that stores a set of instructions for wireless communication by a network node. The set of instructions, when executed by one or more processors of the network node, may cause the network node to transmit configuration information, associated with a UE, indicating an SFN scheme to be applied by the UE. The set of instructions, when executed by one or more processors of the network node, may cause the network node to transmit a TCI codepoint, associated with the UE, indicating two or more TCI states associated with the SFN scheme. The set of instructions, when executed by one or more processors of the network node, may cause the network node to transmit a beam indication, associated with the UE, that is associated with a unified TCI state indication, wherein the beam indication indicates at least one of: updated information for a TCI state, from the two or more TCI states, or that the two or more TCI states are associated with multiple downlink channels.

Some aspects described herein relate to an apparatus for wireless communication. The apparatus may include means for receiving, from a network node, configuration information indicating an SFN scheme to be applied by the apparatus. The apparatus may include means for receiving, from the network node, a TCI codepoint indicating two or more TCI states associated with the SFN scheme. The apparatus may include means for receiving, from the network node, a beam indication that is associated with a unified TCI state indication, wherein the beam indication indicates at least one of, updated information for a TCI state, from the two or more TCI states, or that the two or more TCI states are associated with multiple downlink channels.

Some aspects described herein relate to an apparatus for wireless communication. The apparatus may include means for transmitting configuration information, associated with a UE, indicating an SFN scheme to be applied by the UE. The apparatus may include means for transmitting a TCI codepoint, associated with the UE, indicating two or more TCI states associated with the SFN scheme. The apparatus may include means for transmitting a beam indication, associated with the UE, that is associated with a unified TCI state indication, wherein the beam indication indicates at least one of, updated information for a TCI state, from the two or more TCI states, or that the two or more TCI states are associated with multiple downlink channels.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of using beams for communications between a network node and a UE, in accordance with the present disclosure.

FIG. 5 is a diagram illustrating an example associated with single frequency network (SFN) communication, in accordance with the present disclosure.

FIG. 6 is a diagram illustrating an example associated with SFN scheme indications and SFN transmission configuration indicator (TCI) state activation, in accordance with the present disclosure

FIG. 7 is a diagram of an example associated with a unified TCI framework for SFN operations, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

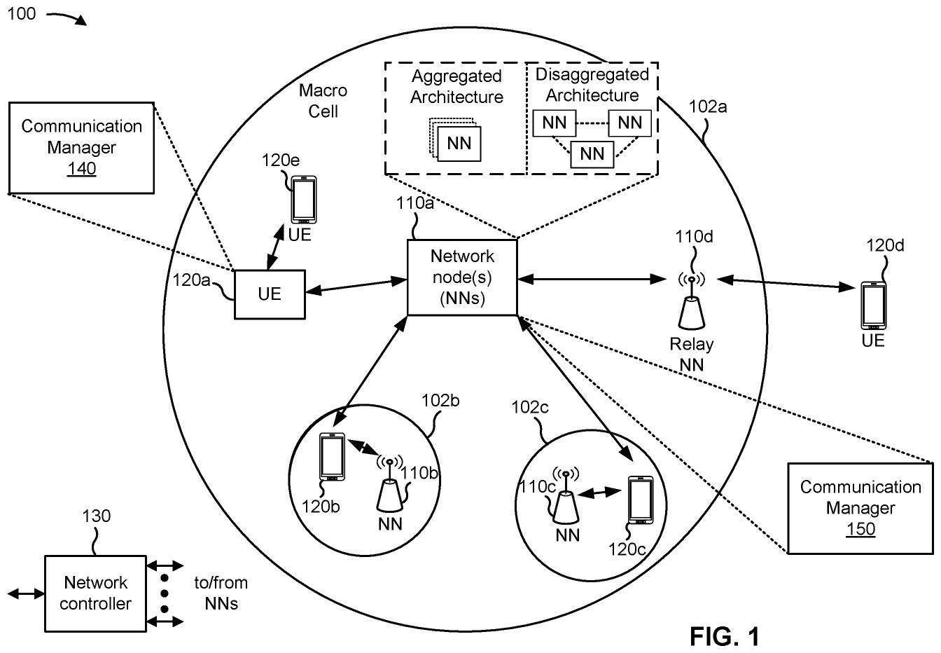

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz—7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node, configuration information indicating a single frequency network (SFN) scheme to be applied by the UE; receive, from the network node, a transmission configuration indicator (TCI) codepoint indicating two or more TCI states associated with the SFN scheme; and receive, from the network node, a beam indication that is associated with a unified TCI state indication, wherein the beam indication indicates at least one of: updated information for a TCI state, from the two or more TCI states, or that the two or more TCI states are associated with multiple downlink channels. Additionally, or alternatively, the communication manager 140 may perform one or more other operations described herein.

In some aspects, the network node 110 may include a communication manager 150. As described in more detail elsewhere herein, the communication manager 150 may transmit configuration information, associated with a UE, indicating an SFN scheme to be applied by the UE; transmit a TCI codepoint, associated with the UE, indicating two or more TCI states associated with the SFN scheme; and transmit a beam indication, associated with the UE, that is associated with a unified TCI state indication, wherein the beam indication indicates at least one of: updated information for a TCI state, from the two or more TCI states, or that the two or more TCI states are associated with multiple downlink channels. Additionally, or alternatively, the communication manager 150 may perform one or more other operations described herein.

As indicated above, FIG. 1 is provided as an example. Other examples may differ from what is described with regard to FIG. 1.

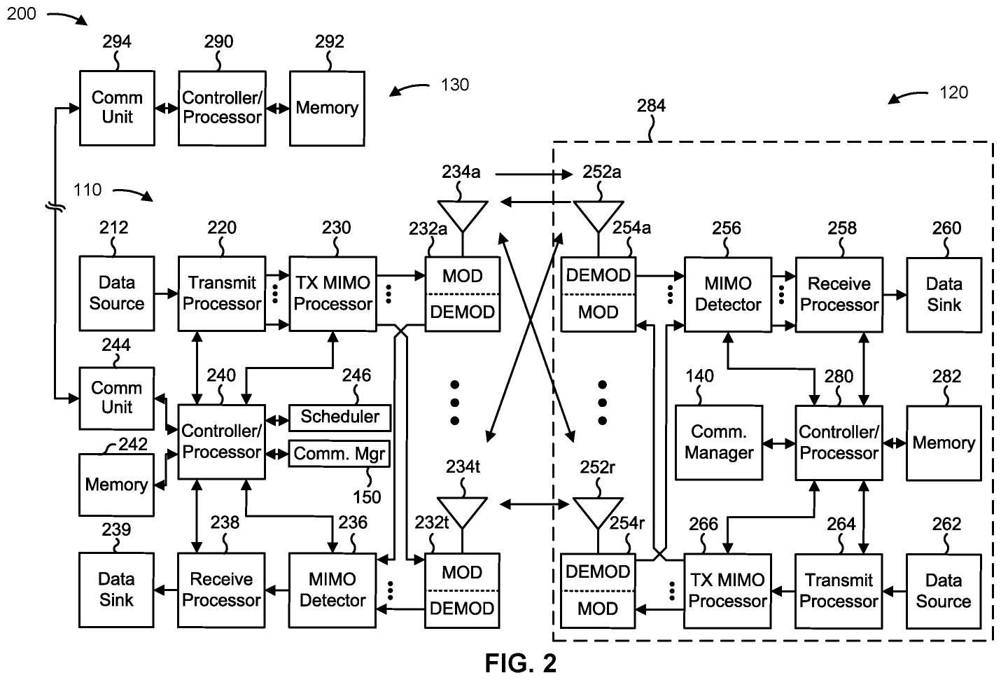

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

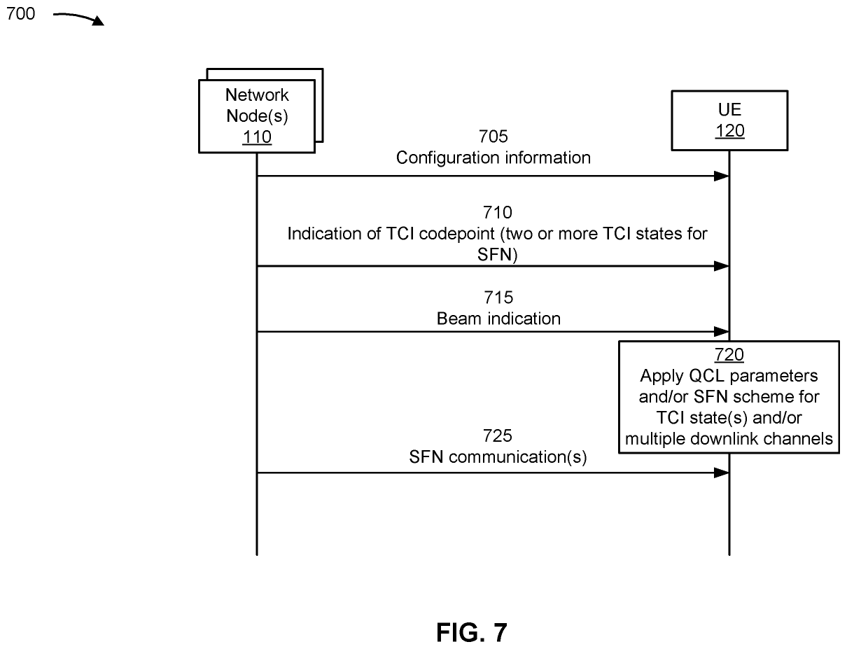

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the ULE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-11).

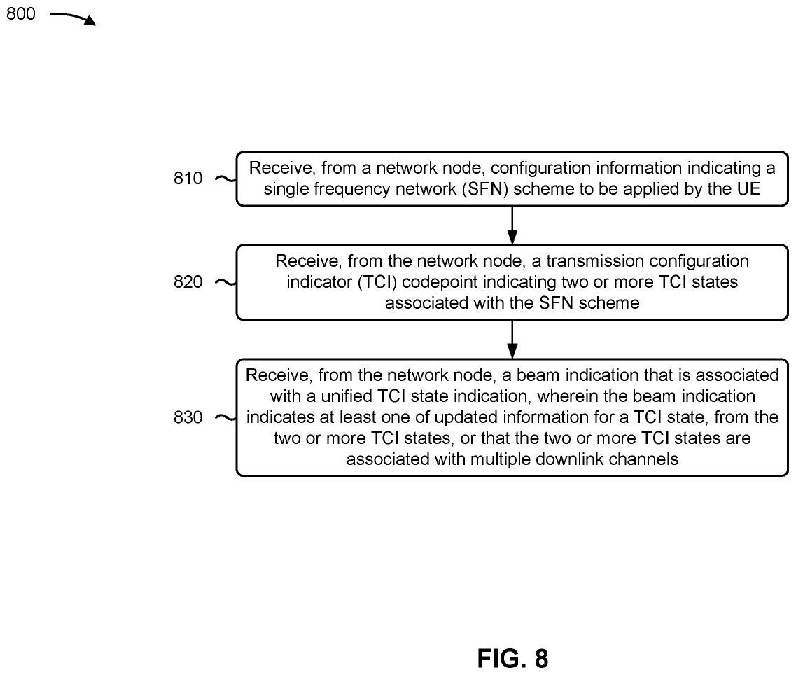

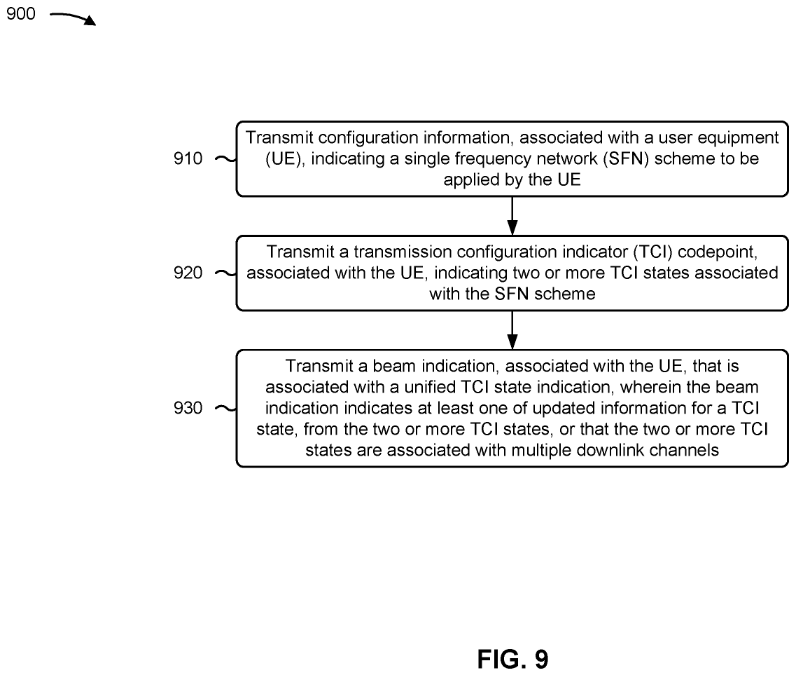

The controller/processor 240 of the network node 110, the controller/processor 280 of the UE 120, and/or any other component(s) of FIG. 2 may perform one or more techniques associated with unified TCI framework for SFN operations, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving, from a network node, configuration information indicating an SFN scheme to be applied by the UE; means for receiving, from the network node, a TCI codepoint indicating two or more TCI states associated with the SFN scheme; and/or means for receiving, from the network node, a beam indication that is associated with a unified TCI state indication, wherein the beam indication indicates at least one of: updated information for a TCI state, from the two or more TCI states, or that the two or more TCI states are associated with multiple downlink channels. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting configuration information, associated with a UE, indicating an SFN scheme to be applied by the UE; means for transmitting a TCI codepoint, associated with the UE, indicating two or more TCI states associated with the SFN scheme; and/or means for transmitting a beam indication, associated with the UE, that is associated with a unified TCI state indication, wherein the beam indication indicates at least one of: updated information for a TCI state, from the two or more TCI states, or that the two or more TCI states are associated with multiple downlink channels. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

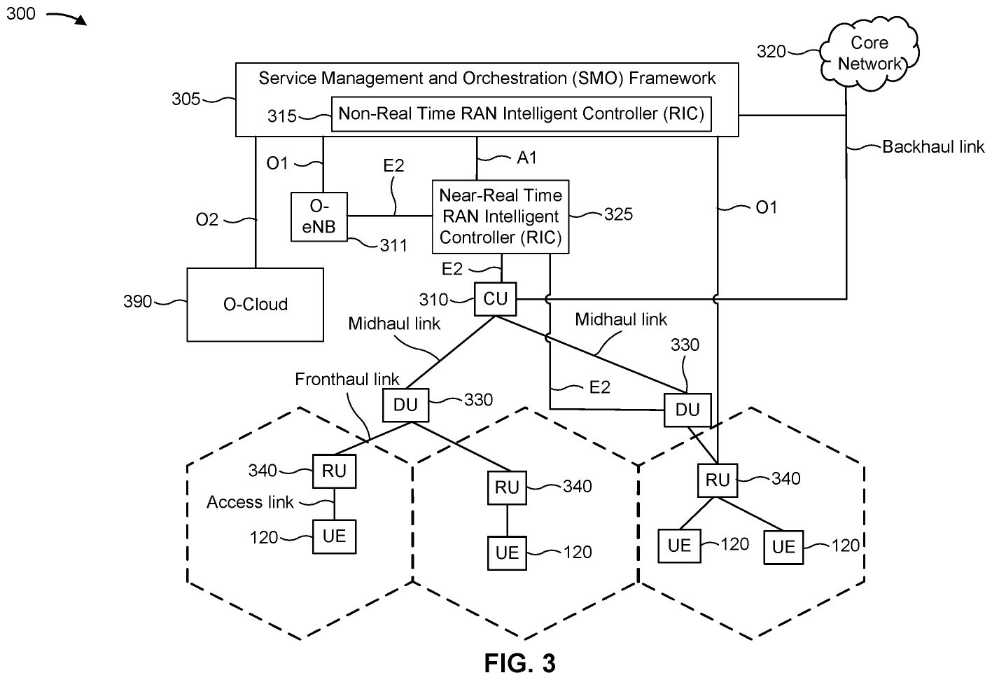

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

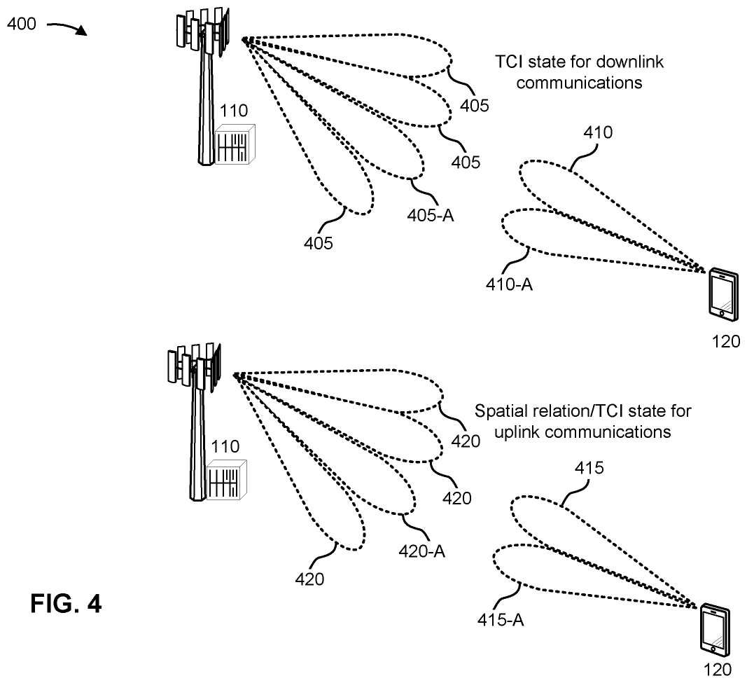

FIG. 4 is a diagram illustrating an example 400 of using beams for communications between a network node and a UE, in accordance with the present disclosure. As shown in FIG. 4, a network node 110 and a UE 120 may communicate with one another.

The network node 110 may transmit to UEs 120 located within a coverage area of the network node 110. The network node 110 and the UE 120 may be configured for beamformed communications, where the network node 110 may transmit in the direction of the UE 120 using a directional NN transmit beam (e.g., a BS transmit beam), and the UE 120 may receive the transmission using a directional UE receive beam. Each NN transmit beam may have an associated beam identifier (ID), beam direction, or beam symbols, among other examples. The network node 110 may transmit downlink communications via one or more NN transmit beams 405.

The UE 120 may attempt to receive downlink transmissions via one or more UE receive beams 410, which may be configured using different beamforming parameters at receive circuitry of the UE 120. The UE 120 may identify a particular NN transmit beam 405, shown as NN transmit beam 405-A, and a particular UE receive beam 410, shown as UE receive beam 410-A, that provide relatively favorable performance (for example, that have a best channel quality of the different measured combinations of NN transmit beams 405 and UE receive beams 410). In some examples, the UE 120 may transmit an indication of which NN transmit beam 405 is identified by the UE 120 as a preferred NN transmit beam, which the network node 110 may select for transmissions to the UE 120. The UE 120 may thus attain and maintain a beam pair link (BPL) with the network node 110 for downlink communications (for example, a combination of the NN transmit beam 405-A and the UE receive beam 410-A), which may be further refined and maintained in accordance with one or more established beam refinement procedures.

A downlink beam, such as an NN transmit beam 405 or a UE receive beam 410, may be associated with a transmission configuration indication (TCI) state. A TCI state may indicate a directionality or a characteristic of the downlink beam, such as one or more quasi co-location (QCL) properties of the downlink beam. A QCL property may include, for example, a Doppler shift, a Doppler spread, an average delay, a delay spread, or spatial receive parameters, among other examples. In some examples, each NN transmit beam 405 may be associated with a synchronization signal block (SSB), and the UE 120 may indicate a preferred NN transmit beam 405 by transmitting uplink transmissions in resources of the SSB that are associated with the preferred NN transmit beam 405. A particular SSB may have an associated TCI state (for example, for an antenna port or for beamforming). The network node 110 may, in some examples, indicate a downlink NN transmit beam 405 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 410 at the UE 120. Thus, the UE 120 may select a corresponding UE receive beam 410 from a set of BPLs based at least in part on the network node 110 indicating an NN transmit beam 405 via a TCI indication. For example, a TCI state information element may indicate a TCI state identification (such as a tci-StateID), a QCL type (such as a qcl-Type1, qcl-Type2, qcl-TypeA, a qcl-TypeB, a qcl-TypeC, or a qcl-TypeD), a cell identification (such as a ServCellIndex), a bandwidth part identification (such as a bwp-Id), or a reference signal identification (such as an NZP-CSI-RS-ResourceId or an SSB-Index), among other examples.

The network node 110 may maintain a set of activated TCI states for downlink shared channel transmissions and a set of activated TCI states for downlink control channel transmissions. The set of activated TCI states for downlink shared channel transmissions may correspond to beams that the network node 110 uses for downlink transmission on a physical downlink shared channel (PDSCH). The set of activated TCI states for downlink control channel communications may correspond to beams that the network node 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

Similarly, for uplink communications, the UE 120 may transmit in the direction of the network node 110 using a directional UE transmit beam, and the network node 110 may receive the transmission using a directional NN receive beam. Each UE transmit beam may have an associated beam ID, beam direction, or beam symbols, among other examples. The UE 120 may transmit uplink communications via one or more UE transmit beams 415.

The network node 110 may receive uplink transmissions via one or more NN receive beams 420 (e.g., BS receive beams). The network node 110 may identify a particular UE transmit beam 415, shown as UE transmit beam 415-A, and a particular NN receive beam 420, shown as NN receive beam 420-A, that provide relatively favorable performance (for example, that have a best channel quality of the different measured combinations of UE transmit beams 415 and NN receive beams 420). In some examples, the network node 110 may transmit an indication of which UE transmit beam 415 is identified by the network node 110 as a preferred UE transmit beam, which the network node 110 may select for transmissions from the UE 120. The UE 120 and the network node 110 may thus attain and maintain a BPL for uplink communications (for example, a combination of the UE transmit beam 415-A and the NN receive beam 420-A), which may be further refined and maintained in accordance with one or more established beam refinement procedures. An uplink beam, such as a UE transmit beam 415 or an NN receive beam 420, may be associated with a spatial relation. A spatial relation may indicate a directionality or a characteristic of the uplink beam, similar to one or more QCL properties, as described above.

In some cases, to reduce a signaling overhead, uplink spatial relation information may not be signaled to the UE 120. In such examples, the UE 120 may derive or determine the uplink spatial relation information based on a default rule (e.g., a default beam rule). For example, the default rule may indicate that the UE 120 is to derive or determine the uplink spatial relation information based on signal(s) received via a CORESET having a lowest identifier in an active downlink bandwidth part (BWP). For example, the UE 120 may use a downlink TCI state associated with the CORESET as a source TCI state for deriving the uplink spatial relation information. In some cases, the CORESET may be associated with two (or more) TCI states. In such examples, the UE 120 may use a first TCI state (e.g., a TCI state with a lowest identifier or index value) as a source TCI state for deriving the uplink spatial relation information.

In a unified TCI framework, the network (for example, the network node 110) may support common TCI state ID update and activation to provide common QCL information or common uplink transmission spatial filter or filters across a set of configured component carriers (CCs). This type of beam indication may apply to intra-band carrier aggregation (CA), as well as to joint DL/UL and separate downlink/uplink beam indications. The common TCI state ID may imply that one reference signal (RS) determined in accordance with the TCI state(s) indicated by a common TCI state ID is used to provide QCL Type-D indication and to determine UL transmission spatial filters across the set of configured CCs. In a unified TCI state framework, a TCI state may be provided for downlink beams and uplink beams. In some cases, a joint uplink and downlink TCI state may be defined that indicates a common beam for both uplink communications and downlink communications. In some examples, separate TCI states may be defined for uplink communications and downlink communications, such as one or more uplink TCI states and one or more downlink TCI states.

Some networks may use different beam indication types for indicating one or more beams to use for communication via a set of channels. In some examples, types of beam indication types may include a beam indication that indicates to use a common beam for multiple channels or resources for reference signals, or beam indication types that include a single beam indication that indicates to use a beam for a single channel or a resource for reference signals. As used herein, a unified TCI state indication may refer to a TCI state indication using the unified TCI framework.

For example, a unified TCI state indication may include an indication of a TCI state that may be applied to multiple channels and/or reference signals. For example, in some cases, a TCI state may be used for a downlink beam indication, and a spatial relation may be used for an uplink beam indication. Such beam indications may be referred to herein as “non-unified beam indications.” Non-unified beam indications may be applied to one channel for one communication scheduled in that channel.

In some examples, the network node 110 and the UE 120 may use a unified TCI framework for both downlink and uplink beam indications. In the unified TCI framework, TCI state indications may be used to indicate a joint downlink and uplink TCI state or to indicate separate downlink and uplink TCI states. Such a TCI state indication that may be used to indicate a joint downlink and uplink beam, a separate downlink beam, or a separate uplink beam is referred to herein as a “unified TCI state indication.” A unified TCI state indication (e.g., a joint downlink and uplink TCI state indication and/or separate downlink and uplink TCI state indications) may be applied to multiple channels. For example, the unified TCI state indication of a joint uplink and downlink TCI state may be used to indicate a beam direction for one or more downlink channels (e.g., PDSCH and/or PDCCH) or reference signals (e.g., CSI-RS) and for one or more uplink channels (e.g., physical uplink shared channel (PUSCH) and/or physical uplink control channel (PUCCH)) or reference signals (e.g., a sounding reference signal (SRS)). The unified TCI state indication of a separate downlink TCI state may be used to indicate a beam direction for multiple downlink channels (e.g., PDSCH and PDCCH) or reference signals (e.g., CSI-RS). The unified TCI state indication of a separate uplink TCI state may be used to indicate a beam direction to be used for multiple uplink channels (e.g., PUSCH and PUCCH) or reference signals (e.g., SRS). In some examples, the unified TCI state indication may be “sticky,” such that the indicated beam direction will be used for the channels and/or reference signals to which the TCI state indication applies until a further indication is received.

In some examples, there may be two TCI state indication modes in the unified TCI state framework. A first mode may be a separate downlink and uplink TCI state indication mode, in which separate downlink and uplink TCI states are used to indicate downlink and uplink beam directions for the UE. For example, the separate downlink and uplink TCI state indication mode may be used when the UE is having maximum permissible exposure (MPE) issues to indicate different beam directions, for the UE, for an uplink beam (e.g., a UE Tx beam) and a downlink beam (e.g., a UE Rx beam). A second mode may be a joint downlink and uplink TCI state indication mode, in which a TCI state indication is used to indicate, to the UE, a joint uplink and downlink beam direction. For example, the joint downlink and uplink TCI state indication mode may be used when the UE has channel correspondence between downlink and uplink channels (which may be assumed in some examples), and the same beam direction can be used for an uplink beam (e.g., a UE Tx beam) and a downlink beam (e.g., a UE Rx beam).

In some examples, in the unified TCI state framework, downlink TCI states, uplink TCI states, and/or joint downlink and uplink TCI states may be configured for a UE via RRC signaling from a network node. A medium access control (MAC) control element (MAC-CE), transmitted from the network node to the UE, may activate a number of the RRC-configured TCI states and indicate a mapping of TCI field codepoints. In some examples, one TCI field codepoint may represent a joint downlink and uplink TCI state, and the TCI field codepoint may be used for a joint downlink and uplink beam indication. In some examples, one TCI field may represent a pair of TCI states including a downlink TCI state and an uplink TCI state, and the TCI field codepoint may be used for a separate downlink and uplink beam indication. In some examples, one TCI field codepoint may represent only a downlink TCI state, and the TCI field codepoint may be used for a downlink only beam indication. In some examples, one TCI field codepoint may represent only an uplink TCI state, and the TCI field codepoint may be used for an uplink only beam indication. If the MAC-CE indicates a mapping to only a single TCI field codepoint, the MAC-CE may serve as the beam indication. In this case, the UE 120 may begin applying the beam indication indicated in the MAC-CE a certain time duration (e.g., 3 ms) after a hybrid automatic repeat request acknowledgement (HARQ-ACK) transmitted to the network node 110 in response to the PDSCH communication carrying the MAC-CE.

If the MAC-CE indicates a mapping to more than one TCI field codepoint, DCI including an indication of a TCI field codepoint may be used to provide a beam indication to the UE. For example, the UE 120 may receive (e.g., via a PDCCH communication) DCI that includes an indication of a TCI field codepoint. The TCI field codepoint may map to a unified TCI state indication, which may correspond to a joint downlink and uplink TCI state, a separate downlink and uplink TCI state pair, a downlink only TCI state, or an uplink only TCI state. In some examples, downlink DCI (e.g., DCI format 1_1/1_2), with or without a downlink assignment, may be used to provide the beam indication (e.g., the indication of the TCI field codepoint). The DCI that includes the indication of the TCI field codepoint may be referred to a “beam indication DCI.”

As indicated above, FIG. 4 is provided as an example. Other examples may differ from what is described with respect to FIG. 4.

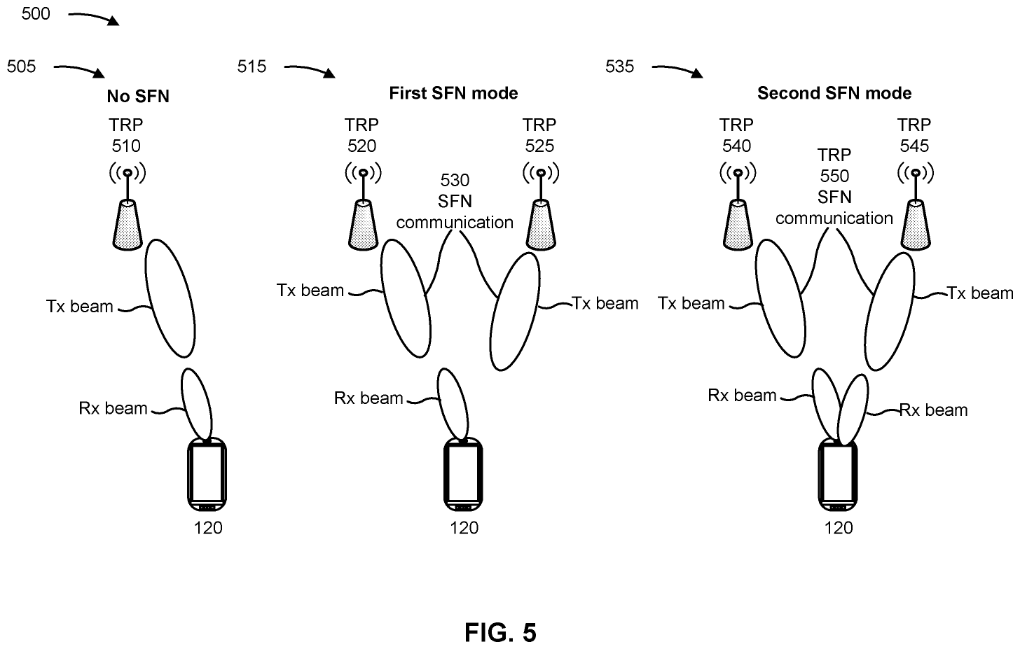

FIG. 5 is a diagram illustrating an example 500 associated with SFN communication, in accordance with the present disclosure.

In some cases, a UE may operate in an SFN. An SFN may be a network configuration in which multiple cells (e.g., multiple network nodes or multiple cells associated with a single network node) simultaneously transmit the same signal over the same frequency channel. As used herein, “SFN transmissions” may refer to two or more transmissions that are transmitted using the same (or substantially the same) time domain resources and frequency domain resources. For example, an SFN may be a broadcast network. An SFN may enable an extended coverage area without the use of additional frequencies. For example, an SFN configuration may include multiple network nodes in an SFN area that transmit one or more identical signals using the same frequency at the same, or substantially the same, time. In some aspects, an SFN configuration may include other network devices, such as multiple TRPs corresponding to the same network node. A TRP may include a network node 110, a DU, and/or an RU, among other examples. The multiple TRPs may provide coverage for an SFN area. The multiple TRPs may transmit one or more identical signals using the same frequency at the same, or substantially the same, time. In some examples, the identical signal(s) simultaneously transmitted by the multiple network nodes (and/or multiple TRPs) may include a PDSCH signal, a CORESET scheduling the PDSCH, and/or a reference signal (e.g., an SSB, a CSI-RS, a tracking reference signal (TRS), or other reference signals), among other examples.

One use case for an SFN may be in high mobility scenarios, such as a high-speed train scenarios. In such examples, the UE 120 may be moving quickly (e.g., in a high-speed train). TRPs may be deployed (e.g., along an expected path of the UE 120, such as along a track of a high-speed train) to provide coverage for an SFN area. The TRPs may simultaneously transmit SFN communications to the UE 120. As a result, a likelihood that the UE 120 is able to successfully receive the SFN communication while in the high mobility scenario is improved (e.g., because multiple TRPs may be transmitting the SFN communication, as described elsewhere herein).

As shown by reference number 505, an example of communications that do not use an SFN configuration is depicted. A TRP 510 may transmit communications using a transmit (Tx) beam to the UE 120. The transmit beam may be associated with a TCI state. The UE 120 may receive communications (e.g., transmitted by the TRP 510) using a receive (Rx) beam. For example, the UE 120 may identify the TCI state associated with the transmit beam and may use information provided by the TCI state to receive the communications.

As shown by reference number 515, an example of a first SFN mode is depicted. As shown in FIG. 5, a first TRP 520 (or a first network node 110) and a second TRP 525 (or a second network node 110) may transmit an SFN communication 530 to the UE 120. For example, the first TRP 520 and the second TRP 525 may transmit substantially the same information (e.g., the SFN communication 530) to the UE 120 using the same frequency domain resources and the same time domain resources. The first TRP 520 may transmit the SFN communication 530 using a first transmit beam. The second TRP 525 may transmit the SFN communication 530 using a second transmit beam. In the first SFN mode, the UE 120 may be unaware that the SFN communication 530 is transmitted on separate transmit beams (e.g., from different TRPs and/or different network nodes 110). Accordingly, when the multiple network nodes (and/or multiple TRPs) simultaneously transmit the same signal to a UE 120, the SFN configuration may be transparent to the UE 120, and the UE 120 may aggregate, or accumulate, the simultaneous signal transmissions from the multiple TRPs (and/or multiple network nodes 110), which may provide higher signal quality or higher tolerance for multipath attenuation, among other benefits. For example, the UE 120 may receive the SFN communication 530 using a single receive beam (e.g., may use a single spatial receive direction, among other examples, to receive the SFN communication 530). In other words, TCI states of the different transmit beams used to transmit the SFN communication 530 may not be signaled to the UE 120.

As shown by reference number 535, an example of a second SFN mode is depicted. As shown in FIG. 5, a first TRP 540 (or a first network node 110) and a second TRP 545 (or a second network node 110) may transmit an SFN communication 550 to the UE 120. For example, the first TRP 540 and the second TRP 545 may transmit substantially the same information (e.g., the SFN communication 550) to the UE 120 using the same frequency domain resources and the same time domain resources. The first TRP 540 may transmit the SFN communication 550 using a first transmit beam. The second TRP 545 may transmit the SFN communication 550 using a second transmit beam. In the second SFN mode, the UE 120 may be aware that the SFN communication 550 is transmitted on separate transmit beams (e.g., from different TRPs and/or different network nodes 110). For example, a first TCI state of the first transmit beam (e.g., associated with the first TRP 540) and a second TCI state of the second transmit beam (e.g., associated with the second TRP 545) may be signaled to the UE 120. For example, a network node 110 may transmit configuration information (e.g., directly to the UE 120 or to the UE 120 via one or more network nodes) that indicates that the SFN communication 550 may be a combination of transmissions from different TRPs and/or different transmit beams. The UE 120 may use the information associated with the different TRPs and/or different transmit beams (e.g., the first TCI state and the second TCI state) to improve a reception performance of the SFN communication 550. For example, as shown in FIG. 5, the UE 120 may use different spatial directions (e.g., different receive beams) to receive the SFN communication 550 based at least in part on the TCI states of the transmit beam(s) associated with the SFN communication 550. This may improve a performance of the UE 120 because the UE 120 may receive the SFN communication 550 from different transmit beams and/or different TRPs with improved signal strength and/or signal quality, among other examples.

As indicated above, FIG. 5 is provided as an example. Other examples may differ from what is described with respect to FIG. 5.

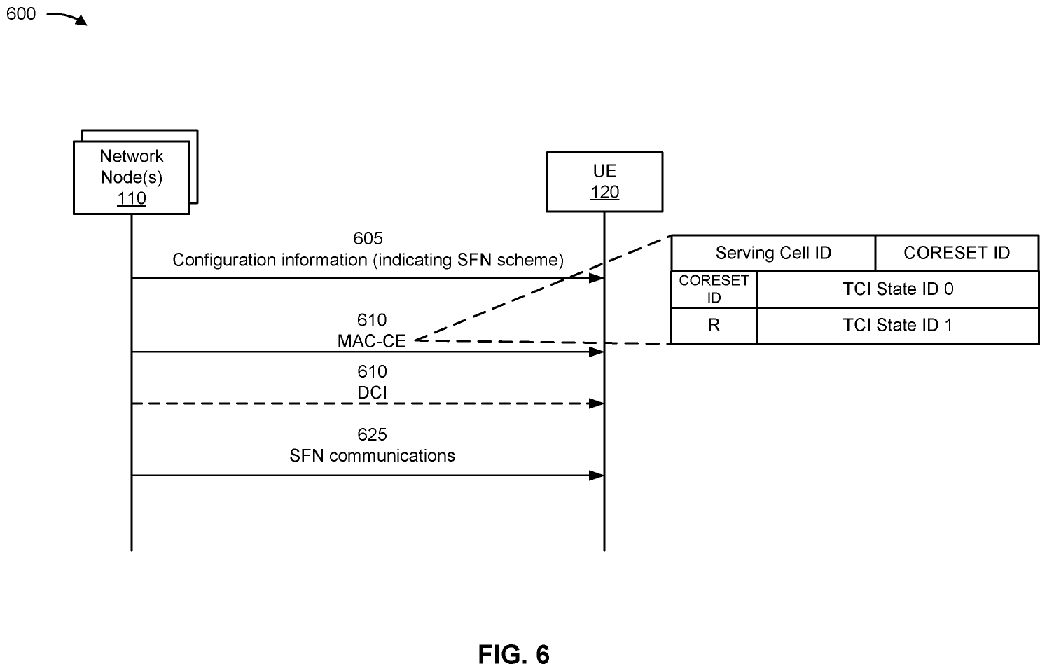

FIG. 6 is a diagram illustrating an example 600 associated with SFN scheme indications and SFN TCI state activation, in accordance with the present disclosure

A PDCCH or a PDSCH (PDCCH/PDSCH) transmission associated with a multi-TRP scenario may be based at least in part on an SFN transmission. A same PDCCH/PDSCH transmission may be simultaneously transmitted from two TRPs using the same time and frequency recourses, which may improve a PDCCH/PDSCH reliability (e.g., in a high speed UE mobility or signal blockage scenario). In some cases, a PDCCH transmission mode may not be the same as a PDSCH transmission mode, where a PDCCH transmission may be carried from a single TRP while a PDSCH transmission may be carried in an SFN manner from both TRPs, or the PDCCH transmission may be carried in the SFN manner from both TRPs while the PDSCH transmission may be carried from a single TRP.

As shown by reference number 605, the network node 110 may transmit, and the UE 120 may receive, configuration information. For example, the configuration information may include an RRC communication. In some examples, an SFN transmission scheme may be identified by a RRC higher layer parameter, which may indicate that a PDCCH/PDSCH transmission may be transmitted in an SFN mode from the two TRPs.

Two SFN transmission schemes may include a first SFN transmission scheme (sfnSchemeA) and a second SFN transmission scheme (sfnSchemeB). In the first SFN transmission scheme (e.g., sfnSchemeA), a PDCCH/DMRS (or PDSCH/DMRS) transmission may be transmitted in an SFN manner (e.g., a same PDCCH from each TRP to achieve diversity). The DMRS of the PDCCH transmission may be associated with two TCI states to enhance a Doppler shift tracking and to enable a multi-beam reception of the PDCCH transmission to enhance reliability. In the first SFN transmission scheme (e.g., sfnSchemeA), a first TCI state may be associated with QCL Type-A and QCL Type-D, and a second TCI state may be associated with QCL Type-A and QCL Type-D, where QCL Type A may be associated with a Doppler shift, a Doppler spread, a delay spread, and an average delay.

In the second SFN transmission scheme (e.g., sfnSchemeB), the PDCCH/DMRS (or PDSCH/DMRS) transmission may be transmitted in the SFN manner. However, a PDCCH transmission of a first TRP may be frequency pre-compensated to align in frequency with a second PDCCH transmission of a second TRP. A TRP-based pre-compensation may be based at least in part on a differential Doppler shift. The DMRS of the PDCCH transmission may be linked with the two TCI states to enable the multi-beam reception of the PDCCH transmission to enhance reliability. In the second SFN transmission scheme, a first TCI state may be associated with QCL Type-A and QCL Type-D, and a second TCI state may be associated with new QCL Type, which may be associated with an average delay and a delay spread, and QCL Type-D.

As shown by reference number 610, for a PDCCH transmission, a CORESET may be activated with two TCI states via a MAC-CE activation command. For a PDSCH transmission, the MAC-CE may indicate one or more TCI codepoints. A TCI codepoint may be associated with two (or more) TCI states. As shown by reference number 610, for a PDSCH transmission, the network node 110 may transmit, and the UE 120 may receive, a DCI communication. The DCI may indicate a TCI codepoint. For example, DCI format 1_1 and 1_2 may indicate a codepoint with two TCI states.

As shown by reference number 625, the network node 110 may transmit, and the UE 120 may receive, one or more SFN communications (e.g., PDCCH transmissions and/or PDSCH transmissions). The UE 120 may receive the one or more SFN communications using information associated with the SFN scheme (e.g., indicated by the configuration information) and a downlink SFN TCI state (e.g., indicated by the MAC-CE and/or the DCI). For example, a downlink SFN TCI state may include two (or more) TCI states. A first TCI state included in the downlink SFN TCI state may be associated with a first TRP (e.g., a first RU, a first network node, or a first base station) and a second TCI state included in the downlink SFN TCI state may be associated with a second TRP (e.g., a second RU, a second network node, or a second base station).

As indicated above, FIG. 6 is provided as an example. Other examples may differ from what is described with respect to FIG. 6.

As described above, in some cases, the network (e.g., one or more network nodes 110) may use a unified TCI framework to indicate TCI states to a UE 120. However, the unified TCI framework may typically be applied in single TRP scenarios. In some examples, the unified TCI framework may be extended to multi-TRP scenarios. For example, a TCI codepoint may be mapped to two TCI states, where each TCI state is associated with a CORESET pool index. However, for SFN scenarios, a CORESET pool index and/or a TRP identifier may not be indicated to the UE 120. Additionally, different channels or reference signals may be associated with different SFN schemes. For example, a first channel may be configured to be associated with multiple SFN schemes, but a second channel may be configured to be associated with a single SFN scheme. Therefore, when a unified TCI state indication is applied for SFN transmissions across multiple channels and/or multiple reference signals, the UE may not be aware of which SFN schemes are applicable for which channels or reference signals of the multiple channels and/or multiple reference signals. Further, in certain SFN schemes, different TCI states may use different QCL information. Therefore, when a unified TCI state indication is applied for SFN transmissions across multiple channels and/or multiple reference signals, the UE may not be aware of how to interpret and/or apply QCL information to the multiple channels and/or multiple reference signals. Therefore, additional clarification to extend the unified TCI framework to SFN scenarios is needed.

Some techniques and apparatuses described herein enable a unified TCI framework for SFN operations. For example, the UE 120 may receive, from a network node 110, configuration information indicating an SFN scheme to be applied by the UE 120. The UE 120 may receive, from the network node 110, a TCI codepoint indicating two or more TCI states associated with the SFN scheme. The UE 120 may receive, from the network node 110, a beam indication that is associated with a unified TCI state indication. In some aspects, the beam indication may indicate updated information for a TCI state, from the two or more TCI states. Additionally, or alternatively, the beam indication may indicate that the two or more TCI states are associated with multiple downlink channels.

In other words, using a unified TCI framework, at least one TCI state of the SFN TCI pair can be indicated and updated. In some implementations, such an indication automatically switches operation of the UE 120 from an SFN to a non-SFN scheme. Further, using the unified TCI framework, a pair of source downlink TCI states can be specified to update multiple downlink channels for SFN operations. In some aspects, the UE 120 may not expect to receive the beam indication if all the applicable downlink channels (e.g., indicated by the beam indication) are not RRC configured with the SFN scheme to be applied to the multiple downlink channels. As another example, the UE 120 may apply the indicated pair of source downlink TCI states to downlink channels, from the multiple downlink channels, that are RRC configured with the SFN scheme to be applied. In some implementations, based on the RRC configured SFN scheme, the UE 120 may identify QCL information to be applied to TCI states indicated via the unified TCI framework.

As a result, the UE 120 may receive updated TCI state information for SFN scenarios using the unified TCI framework. This may enable a downlink SFN TCI state to be indicated to the UE 120 and/or applied by the UE 120 to multiple downlink channels and/or downlink reference signals without a risk that the UE 120 incorrectly applies QCL information to the downlink SFN TCI state and/or applies the downlink SFN TCI state to a downlink channel that is not configured with an applicable SFN scheme. Using the unified TCI framework for SFN scenarios may enable a downlink SFN TCI state to be applied to multiple downlink channels and/or reference signals, thereby reducing a signaling overhead associated with indicating the downlink SFN TCI state. Further, the network (e.g., one or more network nodes 110) may be enabled to update a single TCI state (e.g., from two or more TCI states associated with the downlink SFN TCI state) via a beam indication (e.g., without updating the entire downlink SFN TCI state), thereby reducing an amount of time required to update the single TCI state and/or conserving network resources that would have otherwise been used to update the entire downlink SFN TCI state.

FIG. 7 is a diagram of an example 700 associated with a unified TCI framework for SFN operations, in accordance with the present disclosure. As shown in FIG. 7, one or more network nodes 110 (e.g., a network node 110, a CU, a DU, and/or an RU) may communicate with a UE 120. In some aspects, the network node(s) 110 and the UE 120 may be part of a wireless network (e.g., the wireless network 100). The UE 120 and a network node 110 may have established a wireless connection prior to operations shown in FIG. 7. In some aspects, the UE 120 and a network node 110 may communicate using SFN transmissions and/or SFN schemes (e.g., in a similar manner as described in connection with FIGS. 5 and 6).

In some aspects, actions described as being performed by the network node 110 may be performed by multiple different network nodes. For example, configuration actions may be performed by a first network node (e.g., a CU or a DU), and radio communication actions may be performed by a second network node (e.g., a DU or an RU).

As used herein, the network node 110 “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU transmitting a communication to an RU and the RU transmitting the communication to the UE 120. Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU.

As shown by reference number 705, the network node 110 may transmit, and the UE 120 may receive, configuration information. In some aspects, the UE 120 may receive the configuration information via one or more of system information (SI) signaling, RRC signaling, one or more MAC-CEs, and/or DCI, among other examples. In some aspects, the configuration information may include an indication of one or more configuration parameters (e.g., already stored by the UE 120 and/or previously indicated by the network node 110 or other network device) for selection by the UE 120, and/or explicit configuration information for the UE 120 to use to configure itself, among other examples.

In some aspects, the configuration information may indicate configurations for one or more downlink channels (e.g., the PDCCH and/or the PDSCH). In some aspects, the configuration information may include an SFN configuration. In some aspects, a given downlink channel configuration and/or reference signal configuration (e.g., SSB configuration and/or CSI-RS configuration) may indicate an SFN configuration that is associated with the given downlink channel configuration and/or reference signal configuration.

In some aspects, the configuration information may indicate the SFN operations are enabled for the UE 120. For example, for a given bandwidth part (BWP), the configuration information may indicate that SFN operations are enabled for the UE 120 when communicating using the given BWP. For example, an RRC parameter (e.g., a higher layer parameter) may indicate whether SFN operations are enabled for a given BWP. In some aspects, the configuration information may indicate whether a downlink channel, reference signal, and/or CORESET, among other examples, is configured for SFN operations. For example, an RRC parameter may indicate whether the downlink channel, reference signal, and/or CORESET, among other examples, is configured for SFN operations.

In some aspects, the configuration information may indicate an SFN scheme (e.g., the first SFN transmission scheme (sfnSchemeA) or the second SFN transmission scheme (sfnSchemeB)) to be applied by the UE 120. For example, the configuration information may indicate, for a given downlink channel or reference signal, an SFN scheme (e.g., the first SFN transmission scheme (sfnSchemeA) or the second SFN transmission scheme (sfnSchemeB)) that is to be associated with the given downlink channel or reference signal. In some aspects, the configuration information may indicate that multiple SFN schemes (e.g., both the first SFN transmission scheme (sfnSchemeA) and the second SFN transmission scheme (sfnSchemeB)) are enabled for a given downlink channel or reference signal. In other aspects, the configuration information may indicate that SFN is not enabled for one or more downlink channels and/or reference signals. The configuration information may configure one or more SFN schemes for one or more downlink channels and/or reference signals that are configured for the UE 120.

The UE 120 may configure itself based at least in part on the configuration information. In some aspects, the UE 120 may be configured to perform one or more operations described herein based at least in part on the configuration information.

In some aspects, the UE 120 may transmit, and the network node 110 may receive, a capability report. In some aspects, the capability report may indicate UE support for SFN operations. In some aspects, the capability report may indicate that the UE 120 supports one or more SFN transmission schemes (e.g., the first SFN transmission scheme (sfnSchemeA) and/or the second SFN transmission scheme (sfnSchemeB)). In some aspects, the capability report may indicate that the UE 120 supports a unified TCI framework, as described in more detail elsewhere herein. In some aspects, the capability report may indicate that the UE 120 supports a unified TCI framework for SFN operations. The network node 110 may determine the configuration information based at least in part on the capability report. For example, the UE 120 may be configured with a given SFN transmission scheme based at least in part on the capability report indicating UE support for the given SFN transmission scheme. In some aspects, the UE 120 may receive a beam indication for SFN operations using a unified TCI framework based at least in part on the capability report indicating UE support for the unified TCI framework.

In some aspects, as shown by reference number 710, the network node 110 may transmit, and the UE 120 may receive, an indication of a TCI codepoint indicating two or more TCI states associated with an SFN scheme (e.g., an SFN transmission scheme). For example, the UE 120 may receive a MAC-CE indicating one or more TCI codepoints. A TCI codepoint for the SFN scheme may be associated with, or map to, two or more TCI states. For example, the UE 120 may receive a MAC-CE indicating multiple activated TCI codepoints. A TCI codepoint may be triggered via DCI (e.g., a beam indication DCI). In other words, the MAC-CE may activate one or more TCI codepoints for SFN operations.

In some aspects, the UE 120 may receive a MAC-CE indicating that a CORESET is associated with two or more TCI states (e.g., a MAC-CE activating a CORESET with two or more TCI states). This may indicate that the CORESET (e.g., and a PDCCH) is associated with SFN operations because the CORESET has two (or more) activated TCI states. In some aspects, the CORESET TCI activation may apply to all component carriers associated with (e.g., configured for) the UE 120. In some aspects, the UE 120 may not expect to be configured with different SFN schemes for different CORESETs within a given component carrier. In some aspects, the UE 120 may not expect to receive a MAC-CE indicating two or more TCI states for a CORESET if the CORESET is not RRC configured with an SFN scheme.

As shown by reference number 715, the network node 110 may transmit, and the UE 120 may receive, a beam indication. The beam indication may be included in DCI. For example, the beam indication may be a beam indication DCI. In some aspects, the beam indication may be associated with a unified TCI state indication (e.g., may be associated with a unified TCI framework). For example, the beam indication may include an indication of one or more TCI states that may be applied to multiple channels and/or reference signals. In some aspects, the beam indication may include an indication of one or more TCI states that can be applied for SFN operations.

In some aspects, the beam indication may indicate updated information for a TCI state from two or more TCI states indicated and/or configured for SFN operations. For example, the beam indication may indicate updated information for a TCI state associated with a TCI codepoint for SFN operations (e.g., a TCI codepoint that is mapped to two or more TCI states). In some aspects, the beam indication may indicate a new or updated TCI state to be associated with the TCI codepoint for SFN operations. In other words, the beam indication may replace one TCI state from two or more TCI states that are associated with SFN operations. For example, using the unified TCI framework, at least one TCI state, of an SFN TCI pair, can be indicated and/or updated. For example, the beam indication may include an indication of a new TCI state that is to replace a TCI state that is configured for a downlink SFN TCI state. As another example, the beam indication may include an indication of one or more updated parameters for a TCI state that is configured for a downlink SFN TCI state. As a result, less than all of the two or more TCI states for downlink SFN operations may be dynamically updated and/or replaced. This may reduce latency and/or conserve network resources that would have otherwise been used to update all of the two or more TCI states for downlink SFN operations (e.g., when less than all of the TCI states are actually being updated).

In some aspects, the beam indication may include an indication of the TCI state, from the two or more TCI states, that is to be associated with the updated information. In other words, the beam indication may include an explicit indication of the TCI state (e.g., from two or more TCI states for downlink SFN operations) that is to be updated and/or replaced. For example, which one of the two or more participating TCI states is to be updated may be indicated explicitly (e.g., in the beam indication).

As another example, the UE 120 may identify the TCI state, from the two or more TCI states, that is to be associated with the updated information based at least in part on a rule. The network node 110 may identify or determine the TCI state, from the two or more TCI states, that is to be associated with the updated information in a similar manner as described herein in connection with the UE 120. The rule may be indicated via the configuration information. Additionally, or alternatively, the rule may be defined, or otherwise fixed, by a wireless communication standard, such as the 3GPP. For example, a rule-based framework may be specified to indicate which TCI state is to be updated (e.g., to enable the UE 120 to identify the TCI state that is to be updated and/or replaced). For example, the rule may indicate that a TCI corresponding to a TRP that transmitted the beam indication (e.g., that transmitted the unified TCI state signal) is the TCI state that is to be updated. For example, a network node 110 may be associated with a TCI state (e.g., that is included in two or more TCI states for downlink SFN operations). The UE 120 may identify that the TCI state is to be updated (e.g., using information indicated via the beam indication) based on the beam indication having been transmitted by the network node 110. In other words, the updated information may be applied to the TCI state (e.g., associated with the network node 110 that transmitted the beam indication) based at least in part on receiving the beam indication from the network node 110.

As another example, the rule may indicate that a certain TCI state ID is to be updated and/or replaced. For example, based at least in part on the TCI state ID, the UE 120 may update an SFN TCI pair to ensure continued SFN operation. In other words, the UE 120 may identify the TCI state, from the two or more TCI states, that is to be associated with the updated information based at least in part on an identifier associated with the TCI state. For example, the beam indication may indicate an identifier of a TCI state. The identifier may be mapped to a TCI state in a downlink SFN TCI state. The UE 120 may identify the TCI state to be updated and/or replaced based at least in part on the identifier indicated in the beam indication.

In some aspects, receiving a beam indication indicating updating information for a TCI state that is included in a downlink SFN TCI state may cause the UE 120 to cease SFN operations. For example, the UE 120 may switch an operating mode from the SFN scheme to a non-SFN scheme based at least in part on receiving the beam indication. In some examples, the UE 120 may transmit an indicated of a capability of the UE 120 that indicates that the UE 120 is capable of switching the operating mode (e.g., from the SFN scheme to a non-SFN scheme) in this manner. In other words, the beam indication may automatically switch operation of the UE 120 from an SFN scheme to a non-SFN scheme. This may reduce a complexity associated with updating the TCI state information using the unified TCI framework.

In some aspects, the beam indication may indicate that the two or more TCI states (e.g., associated with downlink SFN operations) are associated with multiple downlink channels and/or reference signals. For example, using the unified TCI framework, a pair of source downlink TCI states can be specified to update multiple downlink channels and/or reference signals. In other words, the beam indication may indicate two or more TCI states for SFN operations that are to be applied (e.g., by the UE 120) to multiple downlink channels and/or reference signals.

In some aspects, the UE 120 may not expect to receive unified TCI framework based beam indication indicating that two or more TCI states for SFN operations that are to be applied to multiple downlink channels and/or reference signals if all the applicable downlink channels and/or reference signals are not RRC configured with an SFN scheme (e.g., with the same SFN transmission scheme). For example, the configuration information may indicate that the SFN scheme is applicable to a first one or more downlink channels. The UE 120 receiving (and/or the network node 110 transmitting) the beam indication indicating that the two or more TCI states are associated with the multiple downlink channels may be based at least in part on the multiple downlink channels being included in the first one or more downlink channels. For example, if one or more downlink channels are not configured with an SFN transmission scheme and/or are not configured with the same SFN transmission scheme, then the network node 110 may refrain from transmitting a beam indication applying two or more TCI states to the one or more downlink channels.

In some aspects, the UE 120 may apply an SFN TCI pair to the applicable DL channels if they are RRC configured with SFN scheme. In other words, the configuration information may indicate that the SFN scheme is applicable to first downlink channels. The first downlink channels may be a subset of the multiple downlink channels (e.g., indicated by the beam indication). The two or more TCI states are applied to the first downlink channels (e.g., that are configured with the SFN transmission scheme). The UE 120 may apply a single TCI state, from the two or more TCI states, to a second one or more downlink channels from the multiple downlink channels (e.g., that are not configured with the SFN transmission scheme). In some aspects, a rule may be defined (e.g., by a wireless communication standard) or configured (e.g., by the network node 110) that indicates which TCI state, from the two or more TCI states, is to be applied to the second one or more downlink channels from the multiple downlink channels (e.g., that are not configured with the SFN transmission scheme). For example, the rule may indicate that a first TCI state (e.g., a TCI state associated with a lowest or highest TCI state ID or index value) is to be applied to the second one or more downlink channels from the multiple downlink channels (e.g., that are not configured with the SFN transmission scheme).

In some aspects, the configuration information may indicate that each of the multiple downlink channels are associated with the SFN scheme. In other words, the UE 120 may expect that all the multiple downlink channels on which the unified TCI indication (e.g., the beam indication) is to be applied are configured with the same SFN scheme. For example, the UE 120 may not expect to receive a beam indication indicating two or more TCI states to be applied to a first downlink channel associated with a first SFN transmission scheme and to a second downlink channel associated with a second SFN transmission scheme. For example, the UE 120 may expect that all downlink channels or reference signals that are indicated by a unified TCI framework-based beam indication for SFN are associated with only a first SFN transmission scheme (sfnSchemeA) or a second SFN transmission scheme (sfnSchemeB).

As shown by reference number 720, the UE 120 may apply QCL parameters and/or an SFN scheme for TCI state(s) and/or for multiple downlink channels indicated by the beam indication. For example, the UE 120 may determine what QCL parameters to apply to certain TCI states. For example, if the UE 120 is configured with the first SFN transmission scheme (sfnSchemeA) for a given downlink channel, then the UE 120 may assume QCL Type-A information from both TCI states. In other words, quasi co-location (QCL)—typeA information from each TCI state, from the two or more TCI states, is applied for SFN operations (e.g., based at least in part on a downlink channel to which the TCI state(s) are to be applied being configured with the first SFN transmission scheme (sfnSchemeA)).

In some aspects, if the UE 120 is configured with the second SFN transmission scheme (sfnSchemeB) on a target downlink channel, then the UE 120 may assume Doppler related QCL parameters are dropped for a second TCI state (e.g., from two TCI states associated with downlink SFN operations). The second TCI state may be identified by the UE 120 based on index values or identifiers of the two TCI states associated with downlink SFN operations. For example, QCL information associated with Doppler parameters for at least one TCI state, from the two or more TCI states, may not applied by the UE 120 (e.g., based at least in part on a downlink channel to which the TCI state(s) are to be applied being configured with the second SFN transmission scheme (sfnSchemeB)).

In some aspects, the second TCI state (e.g., for which Doppler parameters are dropped or not applied) may be an indicated source TCI state. In other examples, the second TCI state (e.g., for which Doppler parameters are dropped or not applied) may be the TCI state that is associated with the network node 110 or TRP that transmits the beam indication. As another example, the second TCI state (e.g., for which Doppler parameters are dropped or not applied) may be identified by the UE 120 based at least in part on a rule. For example, the rule may indicate that a source TCI corresponding to the TRP issuing the unified TCI state signal is the second TCI state (e.g., for which Doppler parameters are dropped or not applied). As another example, the rule may be based at least in part on a TCI state ID (e.g., the rule may indicate that a certain TCI state ID, such as a highest or lowest TCI state ID, is to be the second TCI state for which Doppler parameters are dropped or not applied).

As shown by reference number 725, the network node 110 (and/or another network node 110 or another TRP) may transmit, and the UE 120 may receive, one or more SFN communications. The UE 120 may receive the one or more SFN communications using TCI state(s) and/or other information as indicated by the beam indication. For example, the UE 120 may apply information indicated by the beam indication to one or more downlink channels. The UE 120 may receive the one or more SFN communications via at least one of the one or more downlink channels.

As a result, the UE 120 may receive updated TCI state information for SFN scenarios using the unified TCI framework. This may enable a downlink SFN TCI state to be indicated to the UE 120 and/or applied by the UE 120 to multiple downlink channels and/or downlink reference signals without a risk that the UE 120 incorrectly applies QCL information to the downlink SFN TCI state and/or applies the downlink SFN TCI state to a downlink channel that is not configured with an applicable SFN scheme. Using the unified TCI framework for SFN scenarios may enable a downlink SFN TCI state to be applied to multiple downlink channels and/or reference signals, thereby reducing a signaling overhead associated with indicating the downlink SFN TCI state. Further, the network (e.g., one or more network nodes 110) may be enabled to update a single TCI state (e.g., from two or more TCI states associated with the downlink SFN TCI state) via a beam indication (e.g., without updating the entire downlink SFN TCI state), thereby reducing an amount of time required to update the single TCI state and/or conserving network resources that would have otherwise been used to update the entire downlink SFN TCI state.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., the UE 120) performs operations associated with a unified TCI framework for SFN operations.

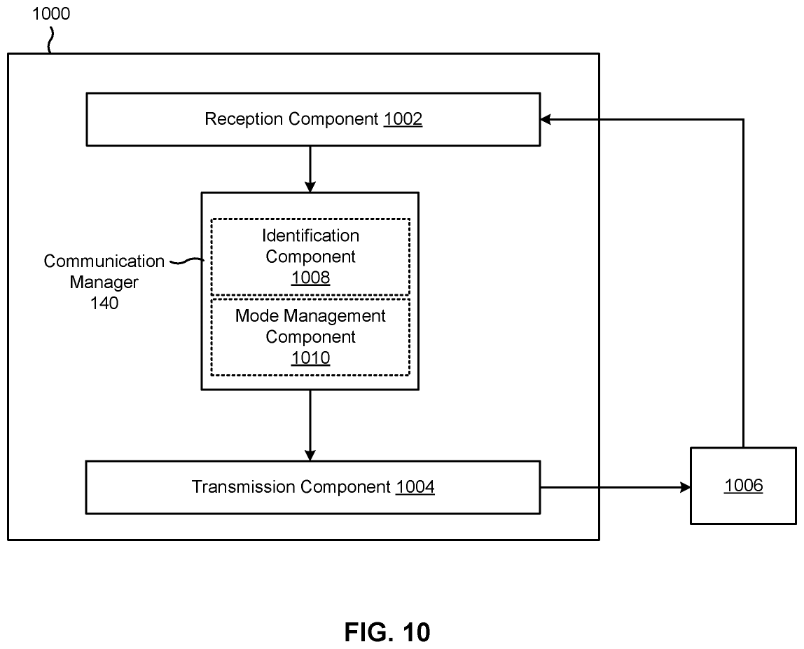

As shown in FIG. 8, in some aspects, process 800 may include receiving, from a network node, configuration information indicating an SFN scheme to be applied by the UE (block 810). For example, the UE (e.g., using communication manager 140 and/or reception component 1002, depicted in FIG. 10) may receive, from a network node, configuration information indicating an SFN scheme to be applied by the UE, as described above.

As further shown in FIG. 8, in some aspects, process 800 may include receiving, from the network node, a TCI codepoint indicating two or more TCI states associated with the SFN scheme (block 820). For example, the UE (e.g., using communication manager 140 and/or reception component 1002, depicted in FIG. 10) may receive, from the network node, a TCI codepoint indicating two or more TCI states associated with the SFN scheme, as described above.

As further shown in FIG. 8, in some aspects, process 800 may include receiving, from the network node, a beam indication that is associated with a unified TCI state indication, wherein the beam indication indicates at least one of: updated information for a TCI state, from the two or more TCI states, or that the two or more TCI states are associated with multiple downlink channels (block 830). For example, the UE (e.g., using communication manager 140 and/or reception component 1002, depicted in FIG. 10) may receive, from the network node, a beam indication that is associated with a unified TCI state indication, wherein the beam indication indicates at least one of: updated information for a TCI state, from the two or more TCI states, or that the two or more TCI states are associated with multiple downlink channels, as described above.

Process 800 may include additional aspects, such as any single aspect or any combination of aspects described below and/or in connection with one or more other processes described elsewhere herein.

In a first aspect, the beam indication includes an indication of the TCI state, from the two or more TCI states, that is to be associated with the updated information.

In a second aspect, alone or in combination with the first aspect, process 800 includes identifying the TCI state, from the two or more TCI states, that is to be associated with the updated information based at least in part on a rule.

In a third aspect, alone or in combination with one or more of the first and second aspects, the network node is associated with the TCI state, and wherein the updated information is applied to the TCI state based at least in part on receiving the beam indication from the network node.

In a fourth aspect, alone or in combination with one or more of the first through third aspects, process 800 includes identifying the TCI state, from the two or more TCI states, that is to be associated with the updated information based at least in part on an identifier associated with the TCI state.

In a fifth aspect, alone or in combination with one or more of the first through fourth aspects, process 800 includes switching an operating mode from the SFN scheme to a non-SFN scheme based at least in part on receiving the beam indication.

In a sixth aspect, alone or in combination with one or more of the first through fifth aspects, the configuration information indicates that the SFN scheme is applicable to a first one or more downlink channels, and wherein receiving the beam indication indicating that the two or more TCI states are associated with the multiple downlink channels is based at least in part on the multiple downlink channels being included in the first one or more downlink channels.

In a seventh aspect, alone or in combination with one or more of the first through sixth aspects, the configuration information indicates that the SFN scheme is applicable to first downlink channels, wherein the first downlink channels are a subset of the multiple downlink channels, wherein the two or more TCI states are applied to the first downlink channels, and wherein a single TCI state, from the two or more TCI states, is applied to a second one or more downlink channels from the multiple downlink channels.

In an eighth aspect, alone or in combination with one or more of the first through seventh aspects, QCL-typeA information from each TCI state, from the two or more TCI states, is applied for SFN operations.

In a ninth aspect, alone or in combination with one or more of the first through eighth aspects, QCL information associated with Doppler parameters for at least one TCI state, from the two or more TCI states, is not applied by the UE.

In a tenth aspect, alone or in combination with one or more of the first through ninth aspects, the at least one TCI state is not indicated by the beam indication.

In an eleventh aspect, alone or in combination with one or more of the first through tenth aspects, the at least one TCI state is the TCI state.

In a twelfth aspect, alone or in combination with one or more of the first through eleventh aspects, the at least one TCI state is identified based at least in part on a rule.

In a thirteenth aspect, alone or in combination with one or more of the first through twelfth aspects, the configuration information indicates that each of the multiple downlink channels are associated with the SFN scheme.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with a unified TCI framework for SFN operations.

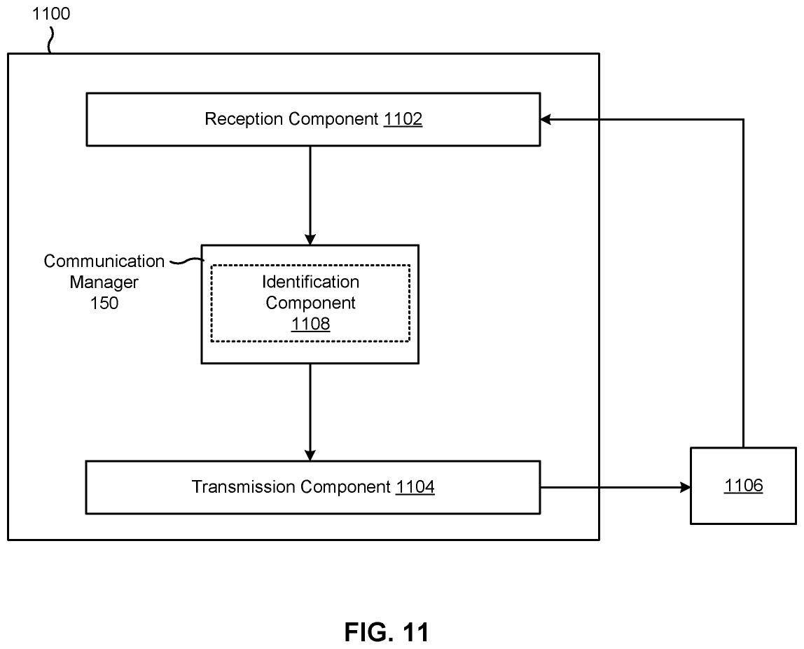

As shown in FIG. 9, in some aspects, process 900 may include transmitting configuration information, associated with a UE, indicating an SFN scheme to be applied by the UE (block 910). For example, the network node (e.g., using communication manager 150 and/or transmission component 1104, depicted in FIG. 11) may transmit configuration information, associated with a UE, indicating an SFN scheme to be applied by the UE, as described above.

As further shown in FIG. 9, in some aspects, process 900 may include transmitting a TCI codepoint, associated with the UE, indicating two or more TCI states associated with the SFN scheme (block 920). For example, the network node (e.g., using communication manager 150 and/or transmission component 1104, depicted in FIG. 11) may transmit a TCI codepoint, associated with the UE, indicating two or more TCI states associated with the SFN scheme, as described above.

As further shown in FIG. 9, in some aspects, process 900 may include transmitting a beam indication, associated with the UE, that is associated with a unified TCI state indication, wherein the beam indication indicates at least one of: updated information for a TCI state, from the two or more TCI states, or that the two or more TCI states are associated with multiple downlink channels (block 930). For example, the network node (e.g., using communication manager 150 and/or transmission component 1104, depicted in FIG. 11) may transmit a beam indication, associated with the UE, that is associated with a unified TCI state indication, wherein the beam indication indicates at least one of: updated information for a TCI state, from the two or more TCI states, or that the two or more TCI states are associated with multiple downlink channels, as described above.

Process 900 may include additional aspects, such as any single aspect or any combination of aspects described below and/or in connection with one or more other processes described elsewhere herein.

In a first aspect, the beam indication includes an indication of the TCI state, from the two or more TCI states, that is to be associated with the updated information.

In a second aspect, alone or in combination with the first aspect, the network node is associated with the TCI state, and wherein the updated information is applied to the TCI state based at least in part on transmitting the beam indication.

In a third aspect, alone or in combination with one or more of the first and second aspects, process 900 includes identifying the TCI state, from the two or more TCI states, that is to be associated with the updated information based at least in part on an identifier associated with the TCI state.

In a fourth aspect, alone or in combination with one or more of the first through third aspects, the beam indication indicates that the UE is to switch an operating mode from the SFN scheme to a non-SFN scheme.

In a fifth aspect, alone or in combination with one or more of the first through fourth aspects, the configuration information indicates that the SFN scheme is applicable to a first one or more downlink channels, and wherein transmitting the beam indication indicating that the two or more TCI states are associated with the multiple downlink channels is based at least in part on the multiple downlink channels being included in the first one or more downlink channels.

In a sixth aspect, alone or in combination with one or more of the first through fifth aspects, the configuration information indicates that the SFN scheme is applicable to first downlink channels, wherein the first downlink channels are a subset of the multiple downlink channels, wherein the two or more TCI states are applied to the first downlink channels, and wherein a single TCI state, from the two or more TCI states, is applied to a second one or more downlink channels from the multiple downlink channels.

In a seventh aspect, alone or in combination with one or more of the first through sixth aspects, QCL-typeA information from each TCI state, from the two or more TCI states, is applied for SFN operations.

In an eighth aspect, alone or in combination with one or more of the first through seventh aspects, QCL information associated with Doppler parameters for at least one TCI state, from the two or more TCI states, is not applied by the UE.

In a ninth aspect, alone or in combination with one or more of the first through eighth aspects, the at least one TCI state is not indicated by the beam indication.

In a tenth aspect, alone or in combination with one or more of the first through ninth aspects, the at least one TCI state is the TCI state.

In an eleventh aspect, alone or in combination with one or more of the first through tenth aspects, the at least one TCI state is identified based at least in part on a rule.

In a twelfth aspect, alone or in combination with one or more of the first through eleventh aspects, the configuration information indicates that each of the multiple downlink channels are associated with the SFN scheme.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of an identification component 1008, and/or a mode management component 1010, among other examples.

In some aspects, the apparatus 1000 may be configured to perform one or more operations described herein in connection with FIG. 7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive, from a network node, configuration information indicating an SFN scheme to be applied by the UE. The reception component 1002 may receive, from the network node, a TCI codepoint indicating two or more TCI states associated with the SFN scheme. The reception component 1002 may receive, from the network node, a beam indication that is associated with a unified TCI state indication, wherein the beam indication indicates at least one of updated information for a TCI state, from the two or more TCI states, or that the two or more TCI states are associated with multiple downlink channels.

The identification component 1008 may identify the TCI state, from the two or more TCI states, that is to be associated with the updated information based at least in part on a rule.

The identification component 1008 may identify the TCI state, from the two or more TCI states, that is to be associated with the updated information based at least in part on an identifier associated with the TCI state.

The mode management component 1010 may switch an operating mode from the SFN scheme to a non-SFN scheme based at least in part on receiving the beam indication.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include an identification component 1108, among other examples.

In some aspects, the apparatus 1100 may be configured to perform one or more operations described herein in connection with FIG. 7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The transmission component 1104 may transmit configuration information, associated with UE, indicating an SFN scheme to be applied by the UE. The transmission component 1104 may transmit a TCI codepoint, associated with the UE, indicating two or more TCI states associated with the SFN scheme. The transmission component 1104 may transmit a beam indication, associated with the UE, that is associated with a unified TCI state indication, wherein the beam indication indicates at least one of updated information for a TCI state, from the two or more TCI states, or that the two or more TCI states are associated with multiple downlink channels.

The identification component 1108 may identify the TCI state, from the two or more TCI states, that is to be associated with the updated information based at least in part on an identifier associated with the TCI state.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: receiving, from a network node, configuration information indicating a single frequency network (SFN) scheme to be applied by the UE; receiving, from the network node, a transmission configuration indicator (TCI) codepoint indicating two or more TCI states associated with the SFN scheme; and receiving, from the network node, a beam indication that is associated with a unified TCI state indication, wherein the beam indication indicates at least one of: updated information for a TCI state, from the two or more TCI states, or that the two or more TCI states are associated with multiple downlink channels.
Aspect 2: The method of Aspect 1, wherein the beam indication includes an indication of the TCI state, from the two or more TCI states, that is to be associated with the updated information.
Aspect 3: The method of any of Aspects 1-2, further comprising: identifying the TCI state, from the two or more TCI states, that is to be associated with the updated information based at least in part on a rule.
Aspect 4: The method of any of Aspects 1-3, wherein the network node is associated with the TCI state, and wherein the updated information is applied to the TCI state based at least in part on receiving the beam indication from the network node.
Aspect 5: The method of any of Aspects 1-4, further comprising: identifying the TCI state, from the two or more TCI states, that is to be associated with the updated information based at least in part on an identifier associated with the TCI state.
Aspect 6: The method of any of Aspects 1-5, further comprising: switching an operating mode from the SFN scheme to a non-SFN scheme based at least in part on receiving the beam indication.
Aspect 7: The method of any of Aspects 1-6, wherein the configuration information indicates that the SFN scheme is applicable to a first one or more downlink channels, and wherein receiving the beam indication indicating that the two or more TCI states are associated with the multiple downlink channels is based at least in part on the multiple downlink channels being included in the first one or more downlink channels.
Aspect 8: The method of any of Aspects 1-7, wherein the configuration information indicates that the SFN scheme is applicable to first downlink channels, wherein the first downlink channels are a subset of the multiple downlink channels, wherein the two or more TCI states are applied to the first downlink channels, and wherein a single TCI state, from the two or more TCI states, is applied to a second one or more downlink channels from the multiple downlink channels.
Aspect 9: The method of any of Aspects 1-8, wherein quasi co-location (QCL)—typeA information from each TCI state, from the two or more TCI states, is applied for SFN operations.
Aspect 10: The method of any of Aspects 1-8, wherein quasi co-location (QCL) information associated with Doppler parameters for at least one TCI state, from the two or more TCI states, is not applied by the UE.
Aspect 11: The method of Aspect 10, wherein the at least one TCI state is not indicated by the beam indication.
Aspect 12: The method of any of Aspects 10-11, wherein the at least one TCI state is the TCI state.
Aspect 13: The method of any of Aspects 10-12, wherein the at least one TCI state is identified based at least in part on a rule.
Aspect 14: The method of any of Aspects 1-13, wherein the configuration information indicates that each of the multiple downlink channels are associated with the SFN scheme.
Aspect 15: A method of wireless communication performed by a network node, comprising: transmitting configuration information, associated with a user equipment (UE), indicating a single frequency network (SFN) scheme to be applied by the UE; transmitting a transmission configuration indicator (TCI) codepoint, associated with the UE, indicating two or more TCI states associated with the SFN scheme; and transmitting a beam indication, associated with the UE, that is associated with a unified TCI state indication, wherein the beam indication indicates at least one of: updated information for a TCI state, from the two or more TCI states, or that the two or more TCI states are associated with multiple downlink channels.
Aspect 16: The method of Aspect 15, wherein the beam indication includes an indication of the TCI state, from the two or more TCI states, that is to be associated with the updated information.
Aspect 17: The method of any of Aspects 15-16, wherein the network node is associated with the TCI state, and wherein the updated information is applied to the TCI state based at least in part on transmitting the beam indication.
Aspect 18: The method of any of Aspects 15-17, further comprising:
identifying the TCI state, from the two or more TCI states, that is to be associated with the updated information based at least in part on an identifier associated with the TCI state.
Aspect 19: The method of any of Aspects 15-18, wherein the beam indication indicates that the UE is to switch an operating mode from the SFN scheme to a non-SFN scheme.
Aspect 20: The method of any of Aspects 15-19, wherein the configuration information indicates that the SFN scheme is applicable to a first one or more downlink channels, and wherein transmitting the beam indication indicating that the two or more TCI states are associated with the multiple downlink channels is based at least in part on the multiple downlink channels being included in the first one or more downlink channels.
Aspect 21: The method of any of Aspects 15-20, wherein the configuration information indicates that the SFN scheme is applicable to first downlink channels, wherein the first downlink channels are a subset of the multiple downlink channels, wherein the two or more TCI states are applied to the first downlink channels, and wherein a single TCI state, from the two or more TCI states, is applied to a second one or more downlink channels from the multiple downlink channels.
Aspect 22: The method of any of Aspects 15-21, wherein quasi co-location (QCL)—typeA information from each TCI state, from the two or more TCI states, is applied for SFN operations.
Aspect 23: The method of any of Aspects 15-21, wherein quasi co-location (QCL) information associated with Doppler parameters for at least one TCI state, from the two or more TCI states, is not applied by the UE.
Aspect 24: The method of Aspect 23, wherein the at least one TCI state is not indicated by the beam indication.
Aspect 25: The method of any of Aspects 23-24, wherein the at least one TCI state is the TCI state.
Aspect 26: The method of any of Aspects 23-25, wherein the at least one TCI state is identified based at least in part on a rule.
Aspect 27: The method of any of Aspects 15-26, wherein the configuration information indicates that each of the multiple downlink channels are associated with the SFN scheme.
Aspect 28: An apparatus for wireless communication at a device, comprising a processor; memory coupled with the processor; and instructions stored in the memory and executable by the processor to cause the apparatus to perform the method of one or more of Aspects 1-14.
Aspect 29: A device for wireless communication, comprising a memory and one or more processors coupled to the memory, the one or more processors configured to perform the method of one or more of Aspects 1-14.
Aspect 30: An apparatus for wireless communication, comprising at least one means for performing the method of one or more of Aspects 1-14.
Aspect 31: A non-transitory computer-readable medium storing code for wireless communication, the code comprising instructions executable by a processor to perform the method of one or more of Aspects 1-14.
Aspect 32: A non-transitory computer-readable medium storing a set of instructions for wireless communication, the set of instructions comprising one or more instructions that, when executed by one or more processors of a device, cause the device to perform the method of one or more of Aspects 1-14.
Aspect 33: An apparatus for wireless communication at a device, comprising a processor; memory coupled with the processor; and instructions stored in the memory and executable by the processor to cause the apparatus to perform the method of one or more of Aspects 15-27.
Aspect 34: A device for wireless communication, comprising a memory and one or more processors coupled to the memory, the one or more processors configured to perform the method of one or more of Aspects 15-27.
Aspect 35: An apparatus for wireless communication, comprising at least one means for performing the method of one or more of Aspects 15-27.
Aspect 36: A non-transitory computer-readable medium storing code for wireless communication, the code comprising instructions executable by a processor to perform the method of one or more of Aspects 15-27.
Aspect 37: A non-transitory computer-readable medium storing a set of instructions for wireless communication, the set of instructions comprising one or more instructions that, when executed by one or more processors of a device, cause the device to perform the method of one or more of Aspects 15-27.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a network node, configuration information indicating a single frequency network (SFN) scheme to be applied by the UE;
receive, from the network node, a transmission configuration indicator (TCI) codepoint indicating two or more TCI states associated with the SFN scheme; and
receive, from the network node, a beam indication that is associated with a unified TCI state indication, wherein the beam indication indicates at least one of:
updated information for a TCI state, from the two or more TCI states, or
that the two or more TCI states are associated with multiple downlink channels.

2. The UE of claim 1, wherein the beam indication includes an indication of the TCI state, from the two or more TCI states, that is to be associated with the updated information.

3. The UE of claim 1, wherein the one or more processors are further configured to:
identify the TCI state, from the two or more TCI states, that is to be associated with the updated information based at least in part on a rule.

4. The UE of claim 1, wherein the network node is associated with the TCI state, and
wherein the updated information is applied to the TCI state based at least in part on receiving the beam indication from the network node.

5. The UE of claim 1, wherein the one or more processors are further configured to:
identify the TCI state, from the two or more TCI states, that is to be associated with the updated information based at least in part on an identifier associated with the TCI state.

6. The UE of claim 1, wherein the one or more processors are further configured to:
switch an operating mode from the SFN scheme to a non-SFN scheme based at least in part on receiving the beam indication.

7. The UE of claim 1, wherein the configuration information indicates that the SFN scheme is applicable to a first one or more downlink channels, and
wherein receiving the beam indication indicating that the two or more TCI states are associated with the multiple downlink channels is based at least in part on the multiple downlink channels being included in the first one or more downlink channels.

8. The UE of claim 1, wherein the configuration information indicates that the SFN scheme is applicable to first downlink channels,
wherein the first downlink channels are a subset of the multiple downlink channels,
wherein the two or more TCI states are applied to the first downlink channels, and
wherein a single TCI state, from the two or more TCI states, is applied to a second one or more downlink channels from the multiple downlink channels.

9. The UE of claim 1, wherein quasi co-location (QCL)—typeA information from each TCI state, from the two or more TCI states, is applied for SFN operations.

10. The UE of claim 1, wherein quasi co-location (QCL) information associated with Doppler parameters for at least one TCI state, from the two or more TCI states, is not applied by the UE.

11. The UE of claim 10, wherein the at least one TCI state is identified based at least in part on a rule.

12. The UE of claim 1, wherein the configuration information indicates that each of the multiple downlink channels are associated with the SFN scheme.

13. A network node for wireless communication, comprising:
a memory; and
one or more processors, coupled to the memory, configured to:
transmit configuration information, associated with a user equipment (UE), indicating a single frequency network (SFN) scheme to be applied by the UE;
transmit a transmission configuration indicator (TCI) codepoint, associated with the UE, indicating two or more TCI states associated with the SFN scheme; and
transmit a beam indication, associated with the UE, that is associated with a unified TCI state indication, wherein the beam indication indicates at least one of:
updated information for a TCI state, from the two or more TCI states, or
that the two or more TCI states are associated with multiple downlink channels.

14. The network node of claim 13, wherein the beam indication includes an indication of the TCI state, from the two or more TCI states, that is to be associated with the updated information.

15. The network node of claim 13, wherein the configuration information indicates that the SFN scheme is applicable to a first one or more downlink channels, and
wherein transmitting the beam indication indicating that the two or more TCI states are associated with the multiple downlink channels is based at least in part on the multiple downlink channels being included in the first one or more downlink channels.

16. A method of wireless communication performed by a user equipment (UE), comprising:
receiving, from a network node, configuration information indicating a single frequency network (SFN) scheme to be applied by the UE;
receiving, from the network node, a transmission configuration indicator (TCI) codepoint indicating two or more TCI states associated with the SFN scheme; and
receiving, from the network node, a beam indication that is associated with a unified TCI state indication, wherein the beam indication indicates at least one of:
updated information for a TCI state, from the two or more TCI states, or
that the two or more TCI states are associated with multiple downlink channels.

17. The method of claim 16, wherein the beam indication includes an indication of the TCI state, from the two or more TCI states, that is to be associated with the updated information.

18. The method of claim 16, further comprising:
identifying the TCI state, from the two or more TCI states, that is to be associated with the updated information based at least in part on a rule.

19. The method of claim 16, wherein the network node is associated with the TCI state, and
wherein the updated information is applied to the TCI state based at least in part on receiving the beam indication from the network node.

20. The method of claim 16, further comprising:
identifying the TCI state, from the two or more TCI states, that is to be associated with the updated information based at least in part on an identifier associated with the TCI state.

21. The method of claim 16, further comprising:
switching an operating mode from the SFN scheme to a non-SFN scheme based at least in part on receiving the beam indication.

22. The method of claim 16, wherein the configuration information indicates that the SFN scheme is applicable to a first one or more downlink channels, and
wherein receiving the beam indication indicating that the two or more TCI states are associated with the multiple downlink channels is based at least in part on the multiple downlink channels being included in the first one or more downlink channels.

23. The method of claim 16, wherein the configuration information indicates that the SFN scheme is applicable to first downlink channels,
wherein the first downlink channels are a subset of the multiple downlink channels,
wherein the two or more TCI states are applied to the first downlink channels, and
wherein a single TCI state, from the two or more TCI states, is applied to a second one or more downlink channels from the multiple downlink channels.

24. The method of claim 16, wherein quasi co-location (QCL)—typeA information from each TCI state, from the two or more TCI states, is applied for SFN operations.

25. The method of claim 16, wherein quasi co-location (QCL) information associated with Doppler parameters for at least one TCI state, from the two or more TCI states, is not applied by the UE.

26. The method of claim 25, wherein the at least one TCI state is not indicated by the beam indication.

27. The method of claim 25, wherein the at least one TCI state is the TCI state.

28. The method of claim 16, wherein the configuration information indicates that each of the multiple downlink channels are associated with the SFN scheme.

29. A method of wireless communication performed by a network node, comprising:
transmitting configuration information, associated with a user equipment (UE), indicating a single frequency network (SFN) scheme to be applied by the UE;
transmitting a transmission configuration indicator (TCI) codepoint, associated with the UE, indicating two or more TCI states associated with the SFN scheme; and
transmitting a beam indication, associated with the UE, that is associated with a unified TCI state indication, wherein the beam indication indicates at least one of:
updated information for a TCI state, from the two or more TCI states, or
that the two or more TCI states are associated with multiple downlink channels.

30. The method of claim 29, wherein the beam indication indicates that the UE is to switch an operating mode from the SFN scheme to a non-SFN scheme.
